(19) United States
(12) Patent Application Publication
(10) Pub. No.: US 2006/0216397 A1
(43) Pub. Date: Sep. 28, 2006

(54) Method to form an animal feed and biodiesel feedstock from Pima cottonseed

(76) Inventor: Timothy M. Kerkman, Tucson, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/388,388

(22) Filed: Mar. 23, 2006

Related U.S. Application Data
(60) Provisional application No. 60/665,007, filed on Mar. 23, 2005.

(51) Int. Cl. A23K 1/00

(52) U.S. Cl. 426/635

(57) ABSTRACT

A method is disclosed to form an animal feed from cottonseed. The method provides cottonseed and an extruder, and extrudes the cottonseed using temperatures greater than 260° F. to form an extrudate. The method extracts from the extrudate oil suitable for a biodiesel feedstock, and then forms an animal feed comprising the extrudate.

### CROSS REFERENCE TO RELATED APPLICATIONS

This Application claims priority from a U.S. Provisional Application having Ser. No. 60/665,007, filed on Mar. 23, 2005.

### FIELD OF THE INVENTION

This invention relates to a method to form an animal feed and a biodiesel feedstock from Pima cottonseed.

### BACKGROUND OF THE INVENTION

Cottonseed comprises seed from upland cotton Gossypium Hirsutum, wild cotton Gossipium Thurberi, and Pima cotton Gossypium Barbadense. Of those three varieties, Pima cottonseed has a higher crude fat content, higher crude protein content, and higher free gossypol content, than Upland seed.

It is known in the art to use cottonseed as an animal feed. The use of cottonseed as an animal feed is limited, however, by the amount of free gossypol. Gossypol [(2,2′-binaphthalene)-8,8′-dicarboxaldehyde-1,1′,6,6′,7,7′-hexahydroxy-5,5′-diisopropyl-3,3′-dimethyl], compound I, is a naturally occurring compound found in the cotton seed.

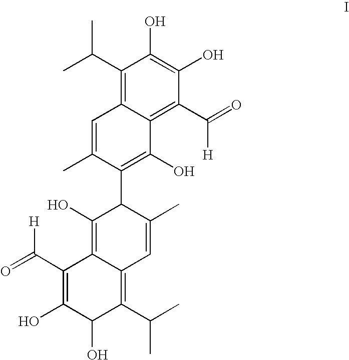

Non-ruminant animals such as poultry and swine can't handle much gossypol before toxicity signs develop. Bovine have the ability to detoxify gossypol because the microorganisms in the rumen bind it so it can't be absorbed. This ability can be overcome at elevated levels of cottonseed feeding.

Toxicity causes primarily heart damage, and deaths due to heart failure have been reported. Most cases, however, have usually been when cattle have been allowed to consume a lot of seed over a long period of time. The livestock industry generally sets the feed limit for Upland cottonseed at 8-10 lbs/day and Pima cottonseed at 4-6 lbs/day, in either event the limiting factor being a maximum of about 20 grams of gossypol per day per animal for lactating cattle.

Toxicity has also been reported in young calves fed several pounds of cottonseed per day. It is not recommended that calves be fed cottonseed before they have a well developed rumen. These problems have been seen primarily in early weaned calves. Young calves will not eat enough cottonseed to present a problem when lactating cows are supplemented with the recommended level.

As a general matter, industry standards limit the ingestion of free gossypol by cattle to about 20 grams per animal per day. Care must be taken to insure that the individual cattle don't exceed the recommended level of intake.

Pima cottonseed is sometimes referred to as a “slick seed” because, unlike upland seed, Pima cottonseed does not have a cellulose lint coating. This lint coating, being composed of cellulose, causes the upland varieties of seed to remain in the rumen of the bovine for an extended period because the bovine digestive system is designed for the digestion of cellulose. Such an increased gastric emptying time facilitates digestion of protein, fat, and other nutrients in the seed. In contrast, Pima seed, lacking the cellulose lint coat, tends to pass through the animals digestive system much more quickly, and the animal does not as fully absorb the nutrients.

The lack of the lint coating also creates storage and handling problems. The angle of repose for Pima cottonseed is less than that of upland seed, thereby limiting the stack or pile height that can be used when storing Pima cottonseed.

As a result, storage costs for Pima cottonseed are higher due to the need for a larger floor footprint, i.e. more square footage, for the same amount of tonnage stored. Storage facilities designed for upland seed varieties cannot withstand the increased pressure resulting from storage of Pima cottonseed.

As a result, Pima cottonseed is often stored outdoors. Spoilage can result from such outdoor storage as from rain water flows relatively unimpeded through the storage piles. Even if stored outdoors, the lint coating of upland seed lint coating sheds water thereby limiting penetration and the resulting seed spoilage. Use of Applicant's method, however, converts Pima cottonseed to a meal or pelletized meal which can be stored indoors, thereby solving these long term storage problems.

As a general matter, there exists a long felt need for a method to minimize the negative factors associated with G. Barbadense seed, i.e. higher gossypol levels and lack of cellulose lint, while at the same time taking advantage of its higher oil and protein content. An effort by the University of California Davis to promote the use of Pima cottonseed as an animal feed commissioned by an industry trade group named Supima comprising an association of Pima cotton growers in 2000-2001 failed to ameliorate the widely perceived negative qualities of G. Barbadense seed as evidenced by the continuing substantially lower market price for Pima cottonseed in comparison with upland seed.

What is needed is a method to process Pima cottonseed to form an animal feed comprising diminished levels of free gossypol and elevated levels of rumen undegradable intestinally absorbable dietary protein. Applicant's invention provides such a method.

### SUMMARY OF THE INVENTION

Applicant's invention comprises a method to form an animal feed from cottonseed. The method provides cottonseed and an extruder, and extrudes the cottonseed using temperatures greater than 260° F. to form an extrudate. The method extracts oil from that extrudate and then forms an animal feed comprising the extrudate.

### BRIEF DESCRIPTION OF THE DRAWINGS

The invention will be better understood from a reading of the following detailed description taken in conjunction with the drawings in which like reference designators are used to designate like elements, and in which:

FIG. 1 is a flow chart summarizing the steps of Applicant's method to form an animal feed from Pima cottonseed using either the apparatus of FIG. 4 or FIG. 5;

FIG. 2 is a flow chart summarizing the steps of Applicant's method to form biodiesel from the cottonseed oil obtained using the method of either FIG. 1 or FIG. 2;

FIG. 3 is a flow chart summarizing the steps of Applicant's method to form an animal feed from Pima cottonseed using either the apparatus of FIG. 6 or FIG. 7;

FIG. 4 is a block diagram showing the apparatus used in a first embodiment of Applicant's method to form an animal feed from Pima cottonseed;

FIG. 5 is a block diagram showing the apparatus used in a second embodiment of Applicant's method to form an animal feed from Pima cottonseed;

FIG. 6 is a block diagram showing the apparatus used in a third embodiment of Applicant's method to form an animal feed from Pima cottonseed;

FIG. 7 is a block diagram showing the apparatus used in a fourth embodiment of Applicant's method to form an animal feed from Pima cottonseed.

### DETAILED DESCRIPTION OF THE PREFERRED EMBODIMENTS

This invention is described in preferred embodiments in the following description with reference to the Figures, in which like numbers represent the same or similar elements.

Applicant has found that the cottonseed market for all varieties of cottonseed is dependent on the dairy industry centered in California. Seed prices set by the dairies determine to a large part whether cottonseed will be processed for oil, or sold whole for dairy feed. The cost of transportation from the source to the dairies is largely determinate. As a result, almost the entire crop in Arizona is sold as dairy feed.

Farther east, in central Texas for example, transportation costs make the seed too expensive to compete with the seed grown in Arizona, New Mexico, and California. This being the case, the seed available Texas is largely used for oil, and the economics of the cottonseed mills in Texas are based on the edible oil market. Drawing a line running north to south through Lubbock, Tex., east of the line there exist various cottonseed oil mills, west of the line cottonseed is sold as cattle feed with the California dairy industry being the largest importer.

The edible oil market demands that cottonseed oil not be subjected to high temperatures resulting in oil discoloration. The edible oil market requires that cottonseed oil have certain color FFA levels and other characteristics so that it may be refined, bleached, degummed, and deodorized economically, since these processes are required to produce a food grade oil from cottonseed. Consequently most cottonseed(upland and pima) oil is extracted via the solvent extracted method from which feed with the qualities produced by the applicants method is not possible. In fact the solvent extracted meal is of a low enough quality that it does not compete well with whole cottonseed, and is one of the reasons that dairies prefer whole seed with its previously described geographic/economic impact) Although less common, mechanically extracted cottonseed oil is also restricted by the demands of the edible oil market. As a result, prior art methods to separate cottonseed oil from cottonseed utilize temperatures less than 250° F.

Applicant's invention comprises a method to process cottonseed to form an animal feed comprising elevated levels of bypass protein in combination with diminished gossypol levels. In certain embodiments, Applicant's method comprises processing cottonseed produced by Extra Long Staple cotton to produce an animal feed, wherein that animal feed comprises elevated levels of bypass protein in combination with diminished gossypol level, and wherein such Extra Long Staple cotton comprises Pima cotton and Egyptian cotton. In certain embodiments, Applicant's method comprises processing Pima cottonseed to produce an animal feed, wherein that feed comprises elevated levels of bypass protein in combination with diminished gossypol levels.

In certain embodiments, Applicant's method processes organic cottonseed to produce an organic oil and an organic animal feed, wherein that organic feed comprises elevated levels of bypass protein and in combination with diminished gossypol levels. By “organic cottonseed,” Applicant means a cottonseed produced from cotton plants grown without the use of chemical herbicides, insecticides, fertilizers, or other chemical supplements. By “organic cottonseed oil,” Applicant means a cottonseed oil obtained from organic cottonseed.

By “organic animal feed”, Applicants mean an animal feed obtained using Applicant's method described herein using organic cottonseed. A need exists for a cottonseed-based organic animal feed by organic dairies which must now utilize one or more expensive organic protein supplements.

A particular need exists for a cottonseed-based organic animal feed comprising high bypass protein and low gossypol levels. Processing organic cottonseed using Applicant's method described herein provides an organic animal feed comprising elevated levels of bypass protein and diminished gossypol levels compared to prior art animal feeds produced using prior art methods.

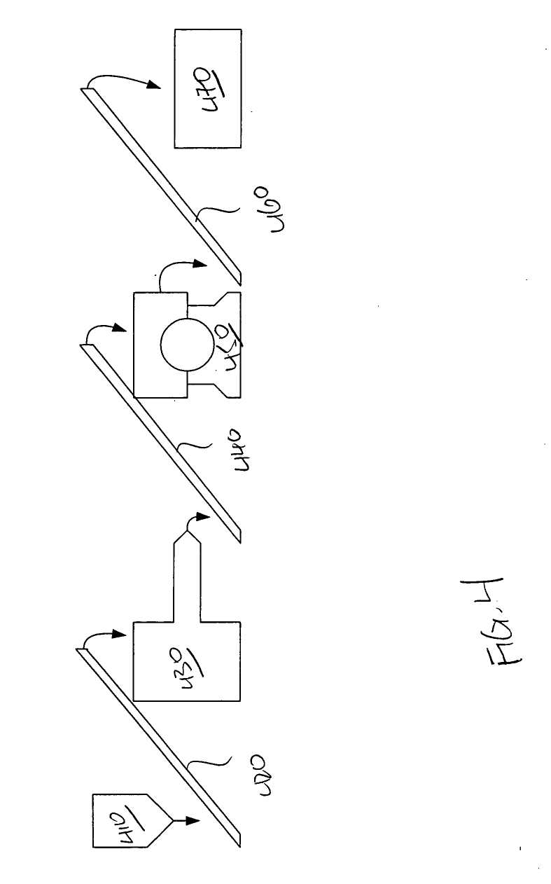

Referring now to FIG. 4, in certain embodiments Applicant's method to process cottonseed to form an animal feed utilizes the apparatus recited in FIG. 4. In certain embodiments, the cottonseed is first disposed in storage unit 410 and is then transferred to extruder 430. In the illustrated embodiment of FIG. 4, cottonseed is dispensed from hopper 410 onto conveyer 420 which provides the cottonseed to extruder 430.

The extrudate from extruder 430 is transferred to an expeller apparatus for further processing. In the illustrated embodiment of FIG. 4, the extrudate from extruder 430 is dispensed onto conveyer 440 which provides that extrudate to expeller 450.

In certain embodiments, the press cake formed by the expeller using the extrudate is transferred to a cooler. In the illustrated embodiment of FIG. 4, the press cake generated by expeller 450 is dispensed onto conveyer 460 which provides that press cake to cooler 470.

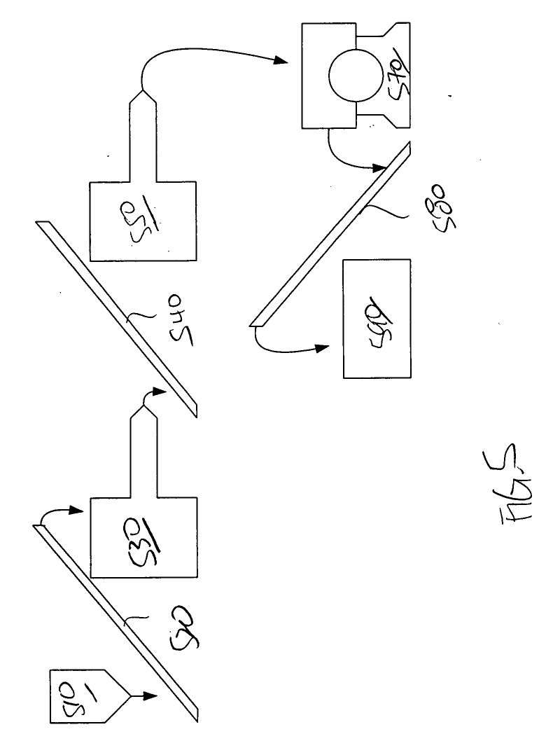

Referring now to FIG. 5, in certain embodiments Applicant's method to process cottonseed to form an animal feed utilizes the apparatus recited in FIG. 5. In certain embodiments, the cottonseed is first disposed in storage unit 510 and is then transferred to a first extruder 530. In the illustrated embodiment of FIG. 5, cottonseed is dispensed from hopper 510 onto conveyer 520 which provides the cottonseed to first extruder 530.

The first extrudate from first extruder 430 is delivered to an expeller apparatus for further processing. In the illustrated embodiment of FIG. 5, the first extrudate from first extruder 530 is dispensed onto conveyer 540 which provides that first extrudate to second extruder 550.

In certain embodiments, the second extrudate from the second extruder is transferred to an expeller for further processing. In the illustrated embodiment of FIG. 5, the second extrudate from second extruder 550 is transferred to expeller 570. In certain embodiments, the second extrudate is dispensed onto a conveyer, such as conveyer 440 (FIG. 4) which then delivers that second extrudate to the expeller 570.

In certain embodiments, the press cake formed by the expeller using the second extrudate is transferred to a cooler. In the illustrated embodiment of FIG. 5, the press cake generated by expeller 570 is dispensed onto conveyer 580 which provides that press cake to cooler 590.

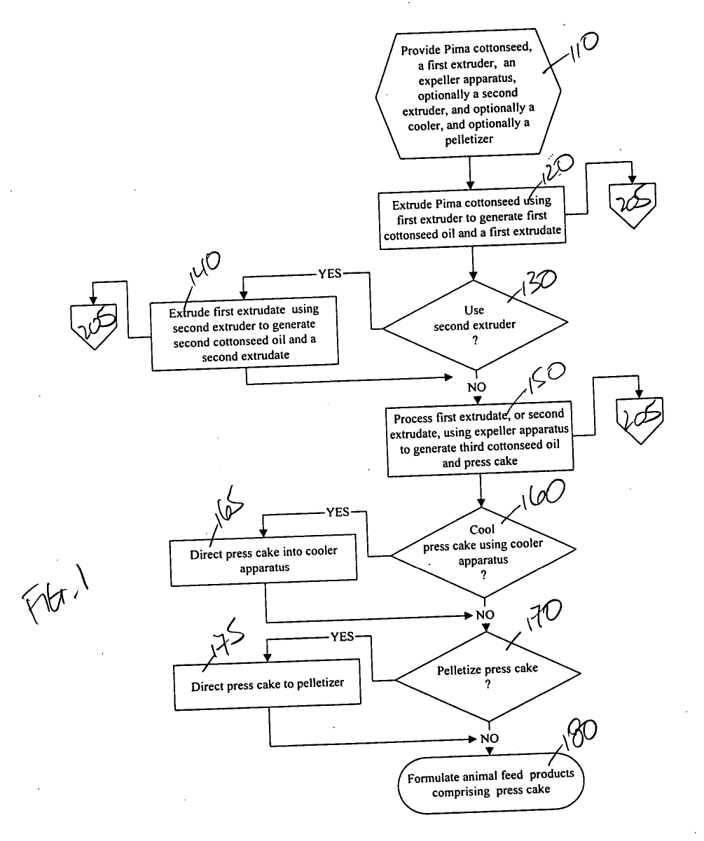

FIG. 1 summarizes the steps of Applicant's method to process cottonseed using the apparatus of FIG. 4 or FIG. 5 to form an improved animal feed. Referring now to FIG. 1, in step 110 Applicant's method provides cottonseed, a first extruder, an expeller, and optionally a second extruder, and optionally a cooler apparatus, and optionally a pelletizer.

In certain embodiments, step 110 comprises providing cottonseed produced from Extra Long Staple cotton, as defined herein. In certain embodiments, step 110 comprises providing Pima cottonseed. In certain embodiments, step 110 comprises providing organic cottonseed, as defined herein. In certain embodiments, step 110 comprises providing organic Pima cottonseed.

By “extruder,” Applicant means a device having one or two screws, where those screws are moveably disposed within a barrel. The extruder barrel is typically a cylinder that houses the screw(s). It provides the bearing surface where shear energy is imparted to the cottonseed. The barrel comprises cast or fabricated steel sections and a smooth inner liner, often made of a wear-resistant material. Heating and cooling media are disposed around the barrel to keep it at the desired temperatures. In certain embodiments, Applicant's extruder comprises up to four different heating/cooling zones.

In step 120, Applicant's method extrudes the cottonseed of step 110 using the extruder of step 110 to form first cottonseed oil and a first extrudate. In certain embodiments, step 120 comprises using dry extrusion machinery such as that manufactured by Insta-Pro, Continental Agricultural Equipment, or Anderson International. In certain embodiments, step 120 comprises using wet (steam) extrusion.

In certain embodiments, step 120 comprises processing the cottonseed in the first extruder at temperatures greater than 260° F. In certain embodiments, step 120 comprises processing the cottonseed at a temperature between about 285° F. and about 330° F. In certain embodiments, step 120 comprises processing the cottonseed at a temperature of 300° F. Applicant has found that processing cottonseed at temperatures between about 285° F. and about 330° F. produces an animal feed having reduced gossypol levels and elevated bypass protein levels.

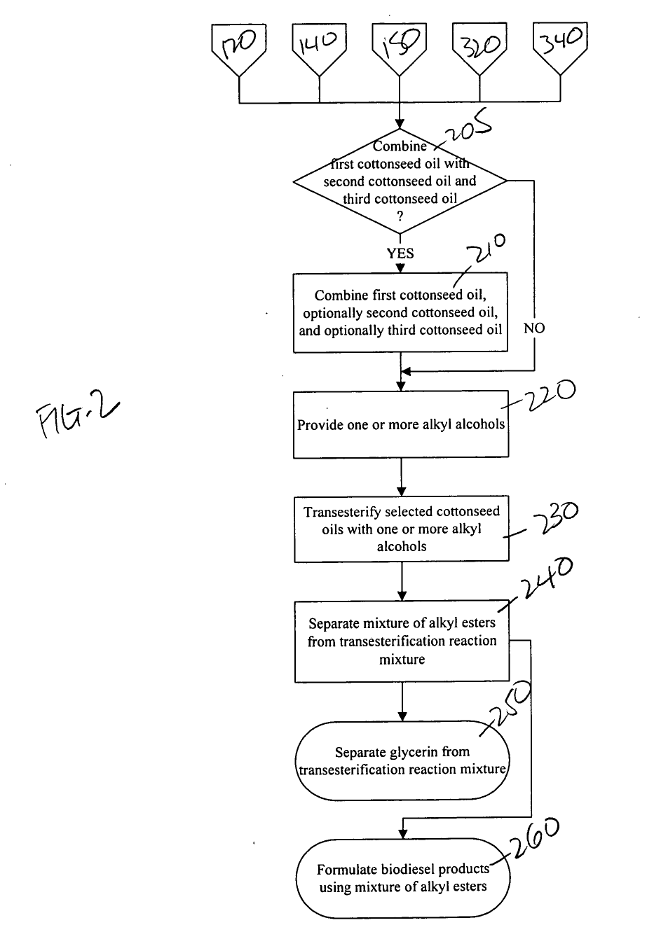

Applicant's method transitions from step 120 to steps 130 and 205 (FIG. 2). In step 205 (FIG. 2), the first cottonseed oil of step 120 is optionally combined with other cottonseed oil fractions generated in the method of FIG. 1 for further processing. In step 130 Applicant's method determines whether to further process the first extrudate of step 120 using a second extruder. If Applicant's method elects in step 130 not to further process the first extrudate of step 120 using a second extruder, then the method transitions from step 130 to step 150.

Alternatively, if Applicant's method elects in step 130 to further process the first extrudate of step 120 using a second extruder, then the method transitions from step 130 to step 140 wherein the method extrudes the first extrudate of step 120 using the second extruder of step 110 to form a second extrudate and second cottonseed oil. In certain embodiments, step 140 comprises using dry extrusion machinery such as that manufactured by Insta-Pro, Continental Agricultural Equipment, or Anderson International. In certain embodiments, step 140 comprises using wet (steam) extrusion.

In certain embodiments, Applicant's method of FIG. 1 comprises a continuous process. In these continuous process embodiments, the second extruder of step 140 differs from the first extruder of step 120. In other embodiments, Applicant's method of FIG. 1 comprises a batch process. In certain of these batch process embodiments, the second extruder of step 140 may be the same as the first extruder of step 120, wherein the first extrudate of step 120 is staged, and subsequently further processed in step 140 using the extruder provided in step 110.

In certain embodiments, step 140 comprises processing the first extrudate in the second extruder at a temperature above 260° F. In certain embodiments, step 120 comprises processing the first extrudate at a temperature between about 285° F. and about 330° F. In certain embodiments, step 120 comprises processing the first extrudate at a temperature of 300° F.

Applicant's method transitions from step 140 to steps 150 and 205 (FIG. 2). In step 205 (FIG. 2), the second cottonseed oil of step 140 is combined with other cottonseed oil fractions generated in the method of FIG. 1 for further processing. In step 150, Applicant's method further processes the first extrudate of step 120 or the second extrudate of step 140 using the expeller apparatus provided in step 110 to form cottonseed press cake and third cottonseed oil. As those skilled in the art will appreciate, expeller pressing is a chemical-free mechanical process that extracts oil from seeds. This method of oil extraction is an alternative to the hexane-extraction method used for many conventional oils. The temperature reached during pressing depends on the hardness of the seed. The harder the seed, more pressure is required to extract the oil, which in turn creates more friction and higher heat. There is no external heat applied during Applicant's expeller pressing.

Applicant's method transitions from step 150 to steps 160 and 205 (FIG. 2). In step 205 (FIG. 2), the third cottonseed oil of step 150 is combined with other cottonseed oil fractions generated in the method of FIG. 1 for further processing. In step 160, Applicant's method determines whether to cool the press cake produced in step 150 using the cooler apparatus optionally provided in step 110.

If Applicant's method elects in step 160 not to cool the press cake of step 150 using a cooler apparatus, then the method transitions from step 160 to step 170. Alternatively, if Applicant's method elects in step 160 to cool the press cake of step 150 using a cooler apparatus, then the method transitions from step 160 to step 165 wherein the method cools the press cake of step 150 using a cooler apparatus to a temperature of 150° F. or less.

Applicant's method transitions from step 165 to step 170 wherein the method determines whether to pelletize the press cake of step 150/165. If Applicant's method elects to not pelletize the press cake of step 150/165, then the method transitions from step 170 to step 180. Alternatively, if Applicant's method elects in step 170 to pelletize the press cake of step 150/165, then the method transitions from step 170 to step 175 wherein the method compacts the press cake of step 150/165 into a plurality of pellets.

In certain embodiments, the pelletizer of step 110 comprises a pellet mill. In certain that pellet mills utilizes steam pelleting. In certain embodiments, that pellet mill utilizes expander pelleting.

Applicant's method transitions from step 175 to step 180 wherein the method formulates an animal feed comprising the press cake of step 150/165. In certain embodiments, the animal feed of step 180 comprises processed cottonseed comprising a free gossypol level between about 730 ppm to about 870 ppm. In certain embodiments, the animal feed of step 180 comprises processed cottonseed comprising about 53 weight percent rumen undigestible protein. In certain embodiments, the animal feed of step 180 comprises processed cottonseed comprising about 32 weight percent intestinally absorbable dietary protein.

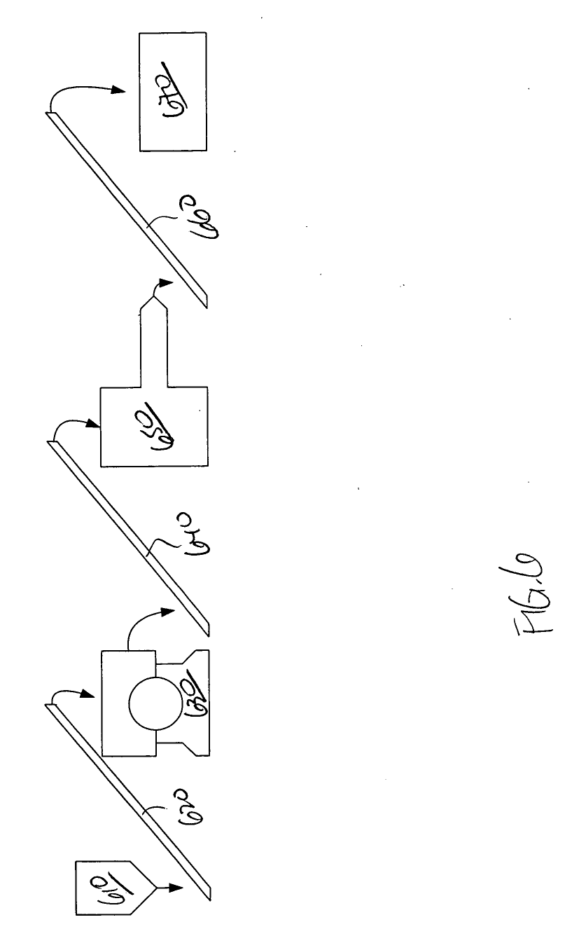

In certain embodiments Applicant's method to process cottonseed to form an animal feed utilizes the apparatus recited in FIG. 6. In certain embodiments, the cottonseed is first disposed in storage unit 610 and is then transferred to expeller 630. In the illustrated embodiment of FIG. 6, cottonseed is dispensed from hopper 610 onto conveyer 620 which provides the cottonseed to expeller 630.

The press cake from expeller 630 is transferred to an extruder for further processing. In the illustrated embodiment of FIG. 6, the press cake from expeller 630 is dispensed onto conveyer 640 which provides that press cake to extruder 650.

In certain embodiments, the extrudate formed by the extruder using the press cake is transferred to a cooler. In the illustrated embodiment of FIG. 6, the extrudate generated by extruder 650 is dispensed onto conveyer 660 which provides that extrudate to cooler 670.

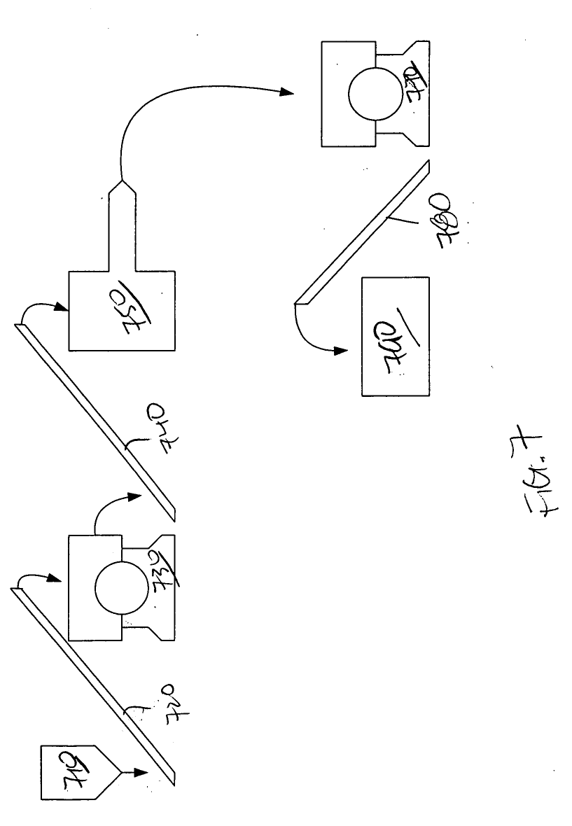

In certain embodiments Applicant's method to process cottonseed to form an animal feed utilizes the apparatus recited in FIG. 7. In certain embodiments, the cottonseed is first disposed in storage unit 710 and is then transferred to first expeller 730. In the illustrated embodiment of FIG. 7, cottonseed is dispensed from hopper 710 onto conveyer 720 which provides the cottonseed to first expeller 730.

The first press cake from first expeller 730 is transferred to an extruder for further processing. In the illustrated embodiment of FIG. 7, the first press cake from expeller 730 is dispensed onto conveyer 740 which provides that press cake to extruder 750.

In certain embodiments, the extrudate formed by the extruder using the first press cake is transferred to a second expeller. In the illustrated embodiment of FIG. 7, the extrudate formed in extruder 750 is transferred to second expeller 770.

In certain embodiments, Applicant's method using the apparatus of FIG. 7 comprises a batch process. In certain of these batch process embodiments, the second expeller 770 may be the same as the first expeller 730, wherein the extrudate formed using extruder 750 is further processed using the expeller 730.

In certain embodiments, the second press cake formed using the second expeller is transferred to a cooler. In the illustrated embodiment of FIG. 7, the second press cake formed using second expeller 770 is dispensed onto conveyer 780 which provides that second press cake to cooler 790.

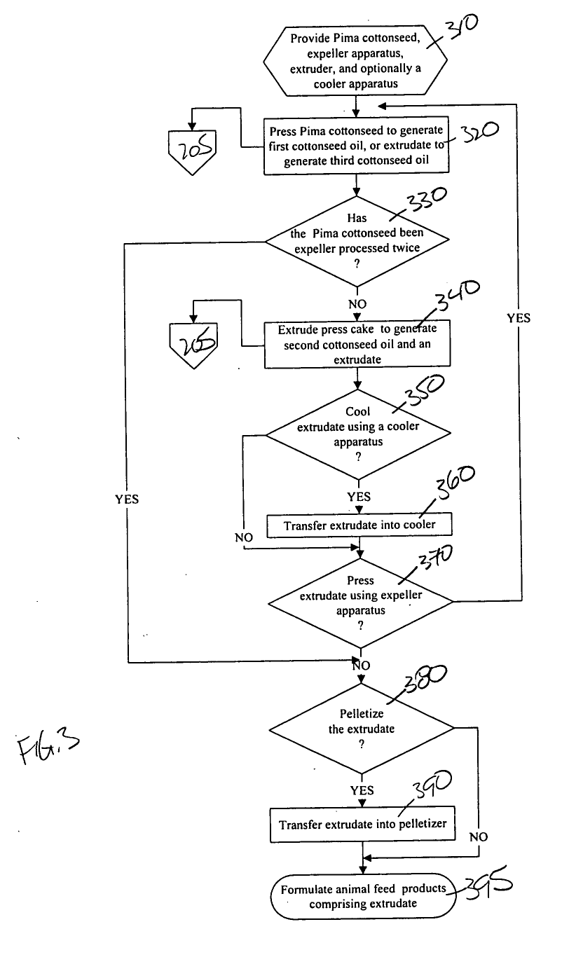

FIG. 3 summarizes the steps of a Applicant's method to process cottonseed to form an improved animal feed using the apparatus of FIG. 6 or FIG. 7. Referring now to FIG. 3, in step 310 Applicant's method provides cottonseed, an expeller, an extruder, and optionally a cooler.

In certain embodiments, step 310 comprises providing cottonseed produced from Extra Long Staple cotton, as defined herein. In certain embodiments, step 310 comprises providing Pima cottonseed. In certain embodiments, step 310 comprises providing organic cottonseed, as defined herein. In certain embodiments, step 310 comprises providing organic Pima cottonseed.

Applicant's method transitions from step 310 to step 320 wherein the method presses the Pima cottonseed of step 310 using the expeller apparatus to form cottonseed press cake and first cottonseed oil. As those skilled in the art will appreciate, expeller pressing is a chemical-free mechanical process that extracts oil from seeds. This method of oil extraction is an alternative to the hexane-extraction method used for many conventional oils. The temperature reached during pressing depends on the hardness of the seed. The harder the seed, more pressure is required to extract the oil, which in turn creates more friction and higher heat. There is no external heat applied during Applicant's expeller pressing.

Applicant's method transitions from step 320 to steps 205 and 330 (FIG. 2). In step 205 (FIG. 2), the method determines whether to combine the first cottonseed oil of step 320 with other cottonseed oil fractions generated in the method of FIG. 3 for further processing. In step 330, Applicant's method determines is the cottonseed has been expeller processed twice. If Applicant's method determines in step 330 that the cottonseed has been expeller processed twice, then the method transitions from step 330 to step 370.

Alternatively, if Applicant's method determines in step 330 that the cottonseed has not been expeller processed twice, then the method transitions from step 330 to step 340 wherein the method extrudes the first press cake of step 320 using the extruder of step 310 to form second cottonseed oil and an extrudate. In certain embodiments, step 340 comprises processing the press cake of step 320 in the extruder at a temperature above 260° F. In certain embodiments, step 340 comprises processing the first press cake of step 320 at a temperature between about 285° F. and about 330° F. In certain embodiments, step 340 comprises processing the first press cake of step 320 at a temperature of 300° F.

Applicant's method transitions from step 340 to steps 205 (FIG. 2) and 350. In step 205 (FIG. 2), the method determines whether to combine the second cottonseed oil of step 340 with other cottonseed oil fractions generated in the method of FIG. 3 for further processing. In step 350 Applicant's method determines whether to cool the extrudate of step 340 using a cooler.

If Applicant's method elects in step 350 not to cool the extrudate of step 340 using a cooler, then the method transitions from step 350 to step 370. Alternatively, if Applicant's method elects in step 350 to cool the extrudate of step 340 using a cooler, then the method transitions from step 350 to step 360 wherein the method transfers the extrudate of step 340 to a cooler, such as cooler 670 (FIG. 6) or cooler 790 (FIG. 7).

Applicant's method transitions from step 360 to step 370 wherein the method determines whether to further process the extrudate of step 340/360 using the expeller of step 310. If Applicant's method elects to further process the extrudate of step 340/360 using the expeller apparatus, then the method transitions from step 370 to step 320 and continues as describer herein.

Alternatively, if Applicant's method elects not to further process the extrudate of step 340/360, then the method transitions from step 370 to step 380 wherein the method determines whether to pelletize the extrudate of step 340/360, or the second press cake of step 320. If Applicant's method elects in step 380 to not pelletize the extrudate of step 340/360, or the second press cake of step 320, then the method transitions from step 380 to step 395. Alternatively, if Applicant's method elects in step 380 to pelletize the extrudate of step 340/360, or the second press cake of step 320, then the method transitions from step 380 to step 390 wherein the method compacts the extrudate of step 340/360, or the second press cake of step 320 into a plurality of pellets.

In certain embodiments, the pelletizer of step 390 comprises a pellet mill. In certain that pellet mills utilizes steam pelleting. In certain embodiments, that pellet mill utilizes expander pelleting.

Applicant's method transitions from step 390 to step 395 wherein the method formulates an animal feed comprising the extrudate of step 340/360, or the second press cake of step 320, in either pelletized or unpelletized form. In certain embodiments, the animal feed of step 395 comprises processed cottonseed comprising a free gossypol level of 1000 ppm or less. In certain embodiments, the animal feed of step 395 comprises processed cottonseed comprising a free gossypol level of 730 ppm or less. In certain embodiments, the animal feed of step 395 comprises processed cottonseed comprising about 53 weight percent rumen undigestible protein. In certain embodiments, the animal feed of step 395 comprises processed cottonseed comprising about 32 weight percent intestinally absorbable dietary protein.

The following example is presented to further illustrate to persons skilled in the art how to make and use Applicants' invention, and to identify a presently preferred embodiment thereof. This example is not intended as a limitation, however, upon the scope of the invention, which is defined by claims appended hereto.

### EXAMPLE I

About 11,000 pounds of Pima cottonseed were processed at Texas A&M University using the method of FIG. 1 described hereinabove. The resulting processed Pima cottonseed of this Example I comprised a free gossypol level of 730 ppm or less. Free Gossypol is typically present in unprocessed Pima cottonseed in levels as high as 12000 ppm, or 1.2% free gossypol by weight. In addition to these reduced free gossypol levels, processed Pima cottonseed of this Example I comprised enhanced rumen undigestible protein (“RUP”). RUP comprises protein-derived materials that pass through the rumen without digestion. For this reason, such RUP materials are sometimes referred to as “bypass” protein.

TABLE IA shows weight percentages for crude protein, ruminally degradable protein (“RDP”), and rumen undigestible protein (“RUP”) for three samples, wherein those samples comprise a University of Minnesota SBM Standard comprising soy bean meal, unprocessed Pima cottonseed, and processed Pima cottonseed of this Example I. Weighed amounts of the three feed samples were individually disposed in a mesh bag, and each bag was then placed inside a different cow's rumen for 16 hours. The bags were then removed, reweighed, and the weight percentage of protein remaining determined. The RDP values comprise the weight percentage of protein that was digested in the rumen. The RUP values comprise the weight percentage of the protein that was not digested in the rumen.

As TABLE IA illustrates processed Pima cottonseed of this Example I comprises a higher level of bypass protein than does either the control or the unprocessed Pima cottonseed.

TABLE IA

| | Crude Protein | RDP | RUP |
|---|---|---|---|
| | (Weight | (Weight | (Weight |
| FEED | Percent) | Percent) | Percent) |
| Soy Bean Control | 52.1 | 68.2 | 31.8 |
| Unprocessed Pima | 21.1 | 82.6 | 17.4 |
| Processed Pima | 28.3 | 46.9 | 53.1 |

TABLE IB shows RUP values for unprocessed Upland cottonseed, unprocessed Pima cottonseed, and the press cake of step 150 in FIG. 1

TABLE 1B

| | RUP |
|---|---|
| FEED | (Weight Percent) |
| Upland Unprocessed | 10.63 |
| Seed | |
| Pima Unprocessed | 8.09 |
| Seed | |
| Processed Pima | 69.97 |

For certain feed applications, a high level of bypass protein, i.e. a high RUP value, is desirable. For example, for cattle breeding purposes providing bovine with feed comprising elevated levels of bypass protein enhances fertility.

For other feed applications, it is desirable that a high level of the protein component pass through the rumen undigested, and subsequently be absorbed in the bovine's intestinal tract. For example, the diary industry has discovered that animal feeds comprising elevated levels of intestinally digestible (“ID”) protein increases milk production.

TABLE 2 shows the percent of the bypass protein for each of the three feeds of TABLE I that is intestinally digestible (“ID”). For example, TABLE 2 illustrates that 60.1 percent of the bypass protein component of processed Pima cottonseed of this Example I is absorbed in the bovine's intestinal tract. TABLE 2 further shows that processed Pima cottonseed of this Example I comprises a much higher level of intestinally digestible protein that either the control or the unprocessed Pima cottonseed.

TABLE 2

| | ID |
|---|---|
| FEED | (Percent) |
| Soy Bean Control | 78.6 |
| Unprocessed Pima | 11.7 |
| Processed Pima | 60.1 |

The intestinally absorbable dietary protein (“IADP”) value of an animal feed comprises the weight percentage of the crude protein component of that feed that is absorbed in the animal's digestive tract. In essence, the IADP represents the effective amount of protein actually provided by that animal feed. TABLE III shows the IAPD for each of the animal feeds of TABLE 1. The IAPD values of TABLE III comprise the multiplication product of the PUR values and the ID values of TABLE III

TABLE III demonstrates that the processed Pima cottonseed of this Example I comprises about 15 times the intestinally absorbable dietary protein of unprocessed Pima cottonseed.

TABLE III

| | RUP | | IADP |
|---|---|---|---|
| FEED | (Weight Percent) | ID | (Weight Percent) |
| Soy Bean Control | 31.8 | 0.786 | 24.99 |
| Unprocessed Pima | 17.4 | 0.117 | 2.04 |
| Processed Pima | 53.1 | 0.601 | 31.91 |

As those skilled in the art will appreciate, “Biodiesel” comprises a clean burning alternative fuel, produced from domestic, renewable resources. Biodiesel contains no petroleum, but it can be blended at any level with petroleum diesel to create a biodiesel blend. It can be used in compression-ignition (diesel) engines with little or no modifications.

Biodiesel is made through a chemical process called transesterification whereby one or more vegetable oils, such as for example cottonseed oil, are reacted with methanol and/or ethanol to form a mixture of alkyl esters and glycerin. Biodiesel comprises a mixture of mono-alkyl esters of long chain fatty acids derived from vegetable oils or animal fats. Biodiesel refers to the pure fuel before blending with diesel fuel. Biodiesel blends are denoted as, “BXX” with “XX” representing the percentage of biodiesel contained in the blend (i.e. B20 is 20% biodiesel, 80% petroleum diesel).

Many small business models for biodiesel producers depend on waste vegetable oil from restaurants or food processing plants as a feedstock for biodiesel production. As those skilled in the art will appreciate, certain tax incentives exist to encourage the formation of biodiesel from unused, or “virgin” vegetable oil. Applicant's invention comprises a method to form biodiesel from the cottonseed oil generated in the method of FIG. 1.

FIG. 2 summarizes the steps of Applicant's method to generate biodiesel feedstock from the cottonseed oil generated using Applicant's method of FIG. 1 or Applicant's method of FIG. 3. Referring now to FIG. 2, in step 205 Applicant's method determines whether to combine the first cottonseed oil of step 115 or step 320 with other cottonseed oil fractions generated using the method of FIG. 1 or the method of FIG. 3.

In certain embodiments of Applicant's method, the first cottonseed oil generated in step 320 by cold pressing is sold for use as an edible oil. In other embodiments, the first cottonseed oil of step 320 is combined with the second cottonseed oil of step 350 and further processed using the method of FIG. 2.

If Applicant's method elects not to combine the first cottonseed oil with the other fractions of cottonseed oil generated using the method of FIG. 1 or the method of FIG. 3, then the method transitions from step 205 to step 220. Alternatively, if Applicant's method elects to combine the first cottonseed oil with the other fractions of cottonseed oil generated using the method of FIG. 1 or the method of FIG. 3, then the method transitions from step 205 to step 210 wherein the method combines the first cottonseed oil generated in step 115 (FIG. 1) or step 320 (FIG. 3), and the second cottonseed oil generated in step 140 (FIG. 1) or step 350 (FIG. 3), and the third cottonseed oil generated in step 165 (FIG. 1). As those skilled in the art will appreciate, cottonseed oil comprises a mixture of triglycerides having structure II.

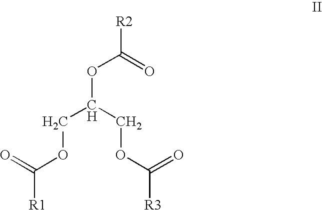

In step 220, Applicant's method provides one or more alkyl alcohols having structure III. 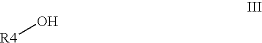
In certain embodiments, step 220 comprises providing one or more n-alkyl alcohols. In certain embodiments, step 220 comprises providing methanol wherein R4 comprises CH₃. In certain embodiments, step 220 comprises providing ethanol wherein R4 comprises CH₃CH₂.

In step 230, Applicant's method transesterifies the cottonseed oil of step 210 using the one or more alkyl alcohols of step 210 to generate a plurality of alkyl esters having structure IV, or V, or VI, and glycerin having structure VII. 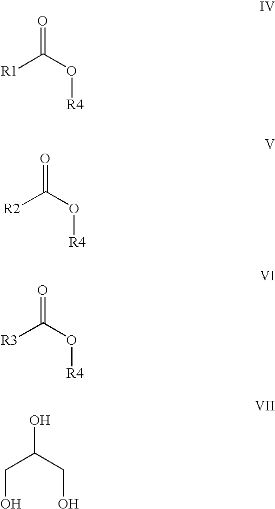
Compounds IV, V, and VI, comprises alkyl esters of the following acids each having an associated designation (X:Y), wherein X indicates the number of carbon atoms in the carboxylate component, and wherein Y indicates the number of double bonds in the carboxylate component: caprylic (8:0), capric (10:0), lauric (12:0), myristic (14:0), myristoleic (14:1), pentadecanoic (15:0), pentadecenoic (15:1), palmitic (16:0), palmitoleic (16:1), heptadecanoic (17:0), heptadecenoic (17:1), stearic (18:0), oleic (18:1), linoleic (18:2), gamma-linolenic (18:3), linolenic (18:3), arachidic (20:0), eicosenoic (20:1), eicosadienoic (20:2), eicosatrienoic (20:3), archidonic (20:4), and behenic (22:0).

In certain embodiments, step 220 comprises an acid-catalyzed transesterification reaction. In certain embodiments, the acid catalyst utilized in step 220 is selected from the group consisting of HCl, H₂SO₄, and mixtures thereof In certain embodiments, step 220 comprises a base catalyzed transesterification reaction. In certain embodiments, the base catalyst of step 220 is selected from the group consisting of KOH, NaOH, NaOCH₃, NaOCH₂CH₃, and mixtures thereof.

In step 240, Applicant's method separates the mixture of alkyl esters IV, V, and VI, from the reaction mixture of step 230. In certain embodiments, the transesterification reaction of step 230 utilizes an aqueous reaction mixture, wherein the glycerin VII generated is water soluble and the esters IV, V, and VII, are water insoluble.

In step 250, Applicant's method separates the glycerin generated in step 230 from the reaction mixture of step 230. In certain embodiments, step 250 comprises, after separating insoluble esters IV, V, and VII, from the reaction mixture of step 230, adding one or more salts, such as for example NaCl, KCl, and the like, to that reaction mixture to “salt out” the glycerin, and then separating that insoluble glycerin component.

In step 260, Applicant's method formulates a biodiesel fuel “BXX,” as described hereinabove, using the esters IV, V, and VII, of step 240.

While the preferred embodiments of the present invention have been illustrated in detail, it should be apparent that modifications and adaptations to those embodiments may occur to one skilled in the art without departing from the scope of the present invention as set forth in the following claims.

I claim:

1. A method to form an animal feed from cottonseed, comprising the steps of:
providing cottonseed and a first extruder;
extruding said cottonseed using said extruder at temperatures greater than 260° F. to form an extrudate;
forming an animal feed comprising said first extrudate.

2. The method of claim 1, wherein said providing cottonseed step comprises providing cottonseed produced by Extra Long Staple cotton.

3. The method of claim 2, wherein said providing cottonseed step comprises providing Pima cottonseed.

4. The method of claim 1, wherein said providing cottonseed step comprises providing organic cottonseed.

5. The method of claim 4, wherein said providing organic cottonseed comprises providing organic Pima cottonseed.

6. The method of claim 1, further comprising the steps of:
providing an expeller;
pressing said cottonseed using said expeller to form a first press cake;
wherein said pressing step is performed before said extruding step.

7. The method of claim 6, further comprising the steps of:
pressing said first extrudate using said expeller to form a second press cake;
wherein said forming an animal feed step comprises forming an animal feed comprising said second press cake.

8. The method of claim 6, further comprising the steps of:
providing a cooler apparatus;
transferring said first extrudate into said cooler before performing said forming step.

9. The method of claim 8, further comprising the step of:
providing a pellet mill;
transferring said first extrudate from said cooler to said pellet mill; and
pelletizing said first extrudate using said pellet mill.

10. The method of claim 1, wherein said extruding step comprises heating said cottonseed at temperatures between about 285° F. and about 330° F.

11. The method of claim 10, wherein said extruding step comprises heating said cottonseed at a temperature of about 300° F.

12. The method of claim 1, further comprising the steps of:
providing a second extruder;
extruding said first extrudate to form a second extrudate;
wherein said forming an animal feed step comprises forming an animal feed comprising said second extrudate.

13. The method of claim 12, wherein said extruding said cottonseed step comprises heating said cottonseed at temperatures between about 285° F. and about 330° F.

14. The method of claim 13, wherein said extruding said cottonseed step comprises heating said cottonseed at a temperature of about 300° F.

15. The method of claim 12, further comprising the steps of:
providing an expeller;
pressing said second extrudate using said expeller to form a press cake;
wherein said forming step comprises forming an animal feed comprising said press cake.

16. An animal feed formed by extruding cottonseed at temperatures between 285° F. and 330° F., wherein said animal feed comprises a free gossypol level of 1000 ppm or less.

17. The animal feed of claim 16, further comprising about 53 weight percent rumen undigestible protein.

18. The animal feed of claim 16, further comprising about 32 weight percent intestinally absorbable dietary protein.

19. An animal feed formed by extruding cottonseed at a temperature of about 300° F., wherein said animal feed comprises a free gossypol level of 1000 ppm or less.

20. The animal feed of claim 19, further comprising about 53 weight percent rumen undigestible protein.

21. The animal feed of claim 19, further comprising about 32 weight percent intestinally absorbable dietary protein.
